(19) United States
(12) Patent Application Publication
(10) Pub. No.: US 2005/0270551 A1
(43) Pub. Date: Dec. 8, 2005

(54) External storage device, image acquisition device, and method and system to control a driver

(76) Inventor: In-sung Choi, Seoul (KR)

Correspondence Address: STANZIONE & KIM, LLP, 919 18TH STREET, N.W., SUITE 440, WASHINGTON, DC, 20006, US

(21) Appl. No.: 11/126,244

(22) Filed: May 11, 2005

(30) Foreign Application Priority Data
Jun. 3, 2004 (KR) 2004-40325

(51) Int. Cl. G06F 3/00; G06F 9/44; G06F 13/00

(52) U.S. Cl. 358/1.13; 719/321; 358/1.15

(57) ABSTRACT

A method of controlling an image acquisition device using a virtual driver and controlling a driver of the image acquisition device that is attachable to a host includes storing a virtual driver corresponding to a real driver for the image acquisition device in the image acquisition device, storing the real driver in an external storage device, activating the virtual driver to control the real driver stored in the external storage device if the image acquisition device and the external storage device are connected to the host, recognizing the image acquisition device and the external storage device connected to the host, and copying the virtual driver to the host if the image acquisition device is recognized. Accordingly, a user does not need to install drivers, and can perform image scanning even when the host is unstable and the real driver is removed.

### CROSS-REFERENCE TO RELATED APPLICATIONS

This application claims priority from Korean Patent Application No. 2004-40325, filed on Jun. 3, 2004 in the Korean Intellectual Property Office, the disclosure of which is incorporated herein in its entirety by reference.

### BACKGROUND OF THE INVENTION

1. Field of the Invention

The present general inventive concept relates to a method of driving an image acquisition device, and more particularly, to a method and system to drive an image acquisition device, such as a scanner, a printer, or a digital camera, by storing a driver to control the image acquisition device in an external storage device, and linking the driver to the corresponding image acquisition device using a virtual driver.

2. Description of the Related Art

In order to scan images using an image processing device, such as a scanner, a driver for controlling the scanner, which resides in a host (e.g., a host computer), is required. Technology Without An Important Name (TWAIN) drivers are typically used to control scanners. The image scanning TWAIN drivers are developed based on TWAIN protocols defined according to a TWAIN standard. The TWAIN drivers act as interfaces between image processing software and scanners or cameras. The TWAIN drivers define protocols and imaging application programming interfaces (APIs) for MICROSOFT WINDOWS®, APPLE MACINTOSH®, and other operating systems. Here, data source (DS) files, developed by respective vendors and contained in the TWAIN drivers, are essential components of the drivers.

FIG. 1 is a flow chart illustrating a conventional method of activating a driver for an image acquisition device. Referring to FIG. 1, the driver may be a TWAIN driver and the image acquisition device may be a scanner.

Referring to FIG. 1, the method includes an operation S100 of installing the driver, an operation S110 of executing an image processing application program, such as PHOTOSHOP® in a host, an operation S120 of driving the TWAIN driver, and an operation S130 of physically scanning an image.

Specifically, in the operation S100, a user first installs the TWAIN driver in a specific directory of an operating system running on the host. Next, in the operation S110, the user executes the image processing application program, such as PHOTOSHOP®, on the host (e.g., a computer). In the operation S120, the user drives the TWAIN driver, which controls the image acquisition device. In the operation S130, image scanning is performed using the TWAIN driver.

Referring to FIG. 1, when the user selects the driver in the image processing application program to perform the image scanning, a data source manager (DSM) is loaded. The DSM displays a list of drivers installed in the specific directory of the host to the user. If the user selects a specific driver from the list of drivers, a user interface (UI) screen is displayed to the user. If the user selects a scan command on the UI screen, the image scanning is performed. The driver may exist in the TWAIN directory of the operating system.

However, the conventional method has the following problems. First, since the DSM searches the specific directory of the operating system to find the driver, the driver containing the data source must always exist in the specific directory, thereby increasing storage requirements of the system. Also, if the host is unstable and the driver is removed or changed, the image acquisition device, such as the scanner, cannot be driven. Secondly, the user must know in advance specific information about the external image acquisition device, such as a manufacturer, a model name, and a model number, in order to operate it.

### SUMMARY OF THE INVENTION

The present general inventive concept provides a method and system to control a driver by storing drivers for various kinds of image acquisition devices (e.g., scanners, printers, digital cameras), including a TWAIN driver for a scanner in an external storage device and linking one of the various drivers to the corresponding image acquisition device using a virtual driver in a host (e.g., a computer). The various drivers may be TWAIN drivers. Thus, the image acquisition device can be conveniently driven, and it is unnecessary for a user to install drivers.

The present general inventive concept also provides a method and system to control a driver in an external storage device by storing in a host using a minimum linking unit. This minimum linking unit links a real driver to a virtual driver, the real driver stored in advance in the external storage device, thereby reducing storage requirements on the host.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of driving a driver of an image acquisition device that is connected to a host, the method comprising: storing a virtual driver that corresponds to a real driver for the image acquisition device in the image acquisition device, storing the real driver in an external storage device that is attachable to the host, and activating the virtual driver to control the real driver stored in the external storage device if the image acquisition device and the external storage device are connected to the host.

The method may further comprise recognizing the image acquisition device and the external storage device connected to the host, and copying the virtual driver to the host if the image acquisition device is recognized.

The external storage device may be any one of a universal serial bus memory, a portable memory card, and a memory stick. The virtual driver may contain at least identification information of the image acquisition device and a function to link the virtual driver with the real driver.

The virtual driver may be driven by a data source manager called by an image processing application program that runs on the host. The operation of copying the virtual driver to the host may comprise copying the virtual driver to the host automatically or allowing a user to copy the virtual driver to the host manually if the image acquisition device is recognized.

The operation of activating the virtual driver may comprise searching the external storage device for the real driver that corresponds to the virtual driver, linking the real driver to the virtual driver, and activating the virtual driver, which in turn activates the real driver. The operation of searching may be performed using a display unit.

The foregoing and/or other aspects and advantages of the present general inventive concept may also be achieved by providing a system to control a driver of an image acquisition device that is attachable to a host, the system comprising the image acquisition device including a storage unit in which a virtual driver that corresponds to a real driver is stored, an external storage device that is attachable to the host in which the real driver is stored, and the host to enable the virtual driver to be copied thereto, and to control the image acquisition device using the virtual driver that activates the real driver.

If the image acquisition device is recognized, the host may control the image acquisition device to copy the virtual driver from the storage unit of the image acquisition device to the host automatically or allow a user to manually copy the virtual driver from the storage unit of the image acquisition device to the host. The host may further comprise a data source manager called by an image processing application program that runs on the host, and the data source manager may activate the virtual driver. The host may display a warning message to a user if the external storage device is not connected to the host.

The foregoing and/or other aspects and advantages of the present general inventive concept may also be achieved by providing an image acquisition device that is attachable to a host, the image acquisition device comprising: a virtual driver storing unit to store a predetermined virtual driver that corresponds to a real driver that is stored in an external storage device that is attachable to the host, wherein the host activates the real driver through the virtual driver to control the image acquisition device.

The foregoing and/or other aspects and advantages of the present general inventive concept may also be achieved by providing an external storage device that is attachable to a host, the external storage device comprising: a storage unit to store a real driver to control an image acquisition device that is attachable to the host, wherein the real driver corresponds to a virtual driver stored in the image acquisition device, and the host activates the real driver through the virtual driver to operate the image acquisition device.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flow chart illustrating a conventional method of activating a driver of an image acquisition device;

FIG. 2 is a block diagram illustrating a system to activate a driver of an image acquisition device according to an embodiment of the present general inventive concept;

FIG. 3 is a flow chart illustrating a method of activating the driver of the image acquisition device of FIG. 2 according to an embodiment of the present general inventive concept;

FIG. 4 is a detailed flow chart illustrating an operation 330 of the method of FIG. 3; and

FIG. 5 is a detailed flow chart illustrating an operation 340 of the method of FIG. 3.

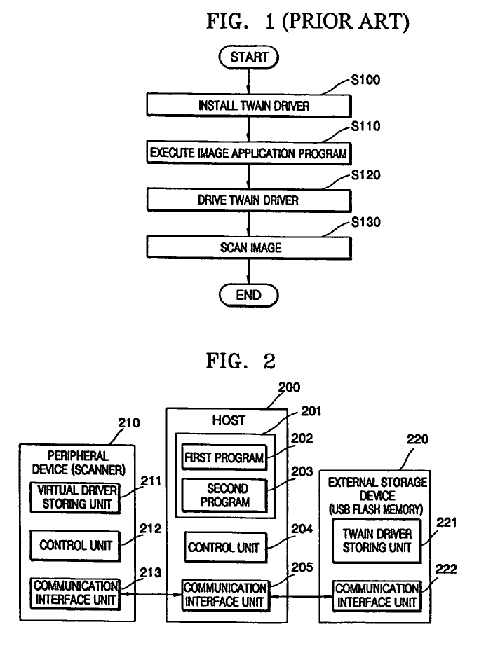

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

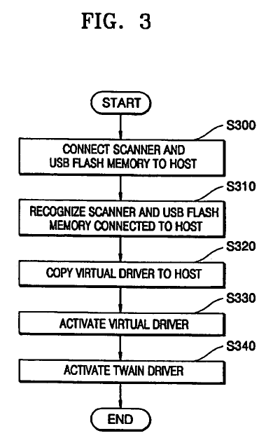

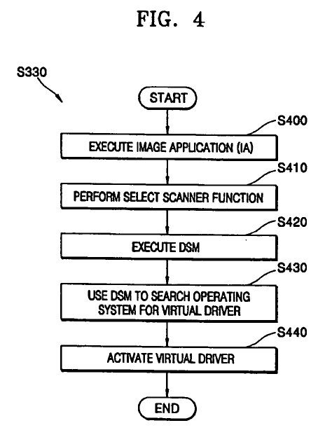

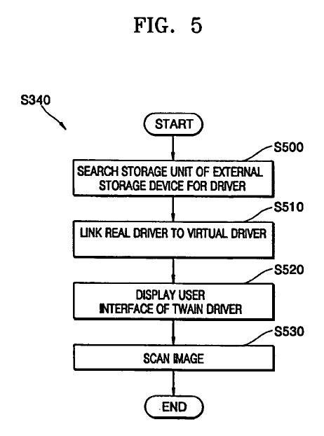

FIG. 2 is a block diagram illustrating a system to activate a driver of an image acquisition device according to an embodiment of the present general inventive concept. FIG. 3 is a flow chart illustrating a method of activating the driver of the image acquisition device of FIG. 2 using an external storage device according to an embodiment of the present general inventive concept. FIG. 4 is a detailed flow chart illustrating an operation S330 of the method of FIG. 3. FIG. 5 is a detailed flow chart illustrating an operation S340 of the method of FIG. 3.

Referring to FIG. 2, a system to activate a driver using an external storage device 220 according to the present general inventive concept includes a host 200, an image acquisition device (e.g., a scanner) 210, and the external storage device 220 (e.g., a USB flash memory device). Although the image acquisition device, the external storage device, and the driver are described below as comprising a scanner, a universal serial bus (USB) flash memory device, and a technology without an important name (TWAIN) driver, respectively, other types of image acquisition devices, external storage devices, and drivers may be used with the present general inventive concept. For example, the image acquisition device may comprise digital cameras, copiers, printers, or other image devices. Similarly, the external devices may comprise a memory card, a memory stick, or other external memory devices. Further, the driver may comprise any software program that operates the image acquisition device. The following description that refers to the scanner, the USB flash memory device, and the TWAIN driver(s) is merely exemplary and is not meant to limit the scope of the present general inventive concept.

The host 200 includes a storage unit 201 in which a first program 202 and a second program 203 are stored, a control unit 204, and a communication interface unit 205.

The first program 202 is an image processing application program, such as PHOTOSHOP®. The second program 203 is a data source manager (DSM) called by the first program 202. The second program (DSM) 203 calls a function DSM_Entry( ) to search for a virtual driver in a specific directory of an operating system running on the host 200.

The communication interface unit 205 of the host 200 is a bi-directional plug-and-play device that may include hardware, software, or both, and is used to communicate with the scanner 210 and the USB flash memory device 220.

The control unit 204 of the host 200 controls the storage unit 201 and the communication interface unit 205 of the host 200 to perform functions according to the present general inventive concept. That is, if the scanner 210 is connected to the host 200, the control unit 204 of the host 200 recognizes the scanner 210, copies a virtual driver from the scanner 210 to the host 200, and links the virtual driver with a real TWAIN driver. Further, if the USB flash memory device 220 is not connected to the host 200 when the real TWAIN driver is linked to the virtual driver, a warning message may be output to a user in a visual or auditory manner.

The scanner 210 includes a virtual driver storing unit 211, a control unit 212, and a communication interface unit 213. The virtual driver storing unit 211 stores the virtual driver therein. The virtual driver stored in the virtual driver storing unit 211 contains unique identification (ID) information corresponding to the image acquisition device (unique device ID (e.g., a scanner ID)), and a function DS_Entry( ). The function DS_Entry( ) contains an entry pointer that links the unique device ID with the real TWAIN driver. Here, the link type is a function prototype for the link to various functions contained in the TWAIN driver. That is, the link type is a function used to link the virtual driver to the real driver (i.e., the real TWAIN driver) and has a format but does not have contents. The real driver contains the functions necessary to operate the scanner 210.

The function DS_Entry( ) searches the USB flash memory device 220 for the real driver and links the virtual driver copied to the host 200 with the real driver stored by the USB flash memory device 220. TWAIN drivers vary depending on vendors, however each TWAIN driver includes common files that are used in all drivers and a data source (DS) file that defines the features of each scanner.

The communication interface unit 213 of the scanner 210 is a bi-directional plug-and-play device that may include hardware, software or both, and is used to communicate with the host 200 and the USB flash memory device 220.

If the scanner 210 is connected to the host 200, the control unit 212 of the scanner 210 transmits a signal to the host 200 via the communication interface 213 of the scanner 210 for the host 200 to recognize the connection therebetween. Through a graphic user interface, the user is given a choice of whether to have the virtual driver copied to the host 200 automatically or to copy it manually. The copying process may be performed according to a particular design.

The USB flash memory device 220 includes a storage unit 221 and a communication interface unit 222. The USB flash memory device 220 also includes a control unit (not shown) that communicates with the control unit 204 of the host 200 via the communication interface unit 222 of the USB flash memory device 220 to be linked to the virtual driver.

The storage unit 221 of the USB flash memory device 220 stores all models of drivers provided by scanner manufacturers or vendors. For example, if the image acquisition device is the scanner 210, the USB flash memory device 220 stores all models of TWAIN drivers. The TWAIN driver includes a DS file, which defines the features of each scanner and common files, which are commonly used in all drivers. Specifically, the DS file defines all the protocols and functions in the real TWAIN driver. The real TWAIN driver is linked to the virtual driver by the DS_Entry( ) function of the virtual driver, which contains the entry pointer.

The communication interface unit 222 of the USB flash memory device 220 is a bi-directional plug-and-play device that includes hardware, software, or both, and is used to communicate with the host 200 and the scanner 210.

A method of activating a driver using an external storage device according to the present general inventive concept will now be explained with reference to FIGS. 2 to 5.

Referring to FIGS. 2 and 3, the method includes an operation S300 of connecting the scanner 210 and the USB flash memory device 220 to the host 200, an operation S310 of recognizing the scanner 210 and the USB flash memory device 220 that are both connected to the host 200, an operation S320 of copying the virtual driver of the scanner 210 to the host 200, an operation S330 of activating the virtual driver in the host 200, and an operation S340 of activating the real driver to operate the scanner 210. The aforementioned method will be explained in further detail below.

In the operation S300, the scanner 210 and the USB flash memory device 220 are connected to the host 200. In the operation S310, the host 200 recognizes that the scanner 210 and the USB flash memory device 220 are connected thereto via the communication interface unit 205 of the host 200.

In the operation S320, the virtual driver stored in the virtual driver storing unit 211 of the scanner 210 is copied to the host 200 via the communication interface unit 213 of the scanner 210. The copied virtual driver is stored in a specific directory (e.g., a TWAIN directory) of the operating system running on the host 200. After the scanner 210 is recognized by the host 200, the virtual driver may be copied automatically, or the virtual driver may be copied manually by the user from the scanner 210 to the host 200.

In the operation S330, the second program 203 (i.e., the data source manager—DSM) searches the host 200 for the virtual driver and, if found, activates the virtual driver. This is explained in more detail below.

FIG. 4 illustrates the operation S330 of the method of activating the driver using the external storage device of FIG. 3. Referring to FIGS. 2 and 4, in an operation S400, the user executes the first program 202 (i.e., the image processing program). In an operation 410, “Select Scanner” is selected in a menu of the image processing application program. In an operation S420, the second program 203 (i.e., the DSM) is executed. In operation S430, the DSM calls the function DSM_Entry( ), which searches the specific directory of the operating system for the virtual driver copied from the scanner 210. In an operation S440, the virtual driver is driven.

Referring back to FIGS. 2 and 3, in the operation S340, the real driver (i.e., the TWAIN driver for the scanner 210), which corresponds to the selected virtual driver and is adapted to physically drive the image acquisition device (i.e., the scanner 210) is driven. This is explained below with reference to FIG. 5.

The virtual driver has the device ID of the scanner 210 and the function DS_Entry( ), which is the basic entry pointer for recognizing the corresponding real TWAIN driver. Accordingly, the function DS_Entry( ) has the address of the corresponding real TWAIN driver in the USB flash memory device 220 and the DS_entry( ) function uses the address to link the device ID of the scanner 210 with the real driver (i.e., the corresponding real TWAIN driver).

Referring to FIGS. 2 and 5, in an operation S500, the storage unit 221 of the USB flash memory device 220 is searched for the real driver (i.e., the corresponding real TWAIN driver). If the real driver is found, the process continues to an operation S510. In the operation S510, the real driver is linked to the virtual driver. In an operation S520, the real driver is activated. Next, in an operation S530, an image can be scanned if the user sends a scan command through a user interface (UI).

Although the image acquisition device, the external storage device, and the driver are described above as comprising a scanner, a universal serial bus (USB) flash memory device, and a TWAIN driver, respectively, other types of image acquisition devices, external storage devices, and drivers may be used with the present general inventive concept. For example, the image acquisition device may comprise digital cameras, copiers, printers, or other image devices. Similarly, the external devices may comprise a memory card, a memory stick, or other external memory devices. Further, the driver may comprise any software program that operates the image acquisition device. The foregoing description that refers to the scanner, the USB flash memory, and the TWAIN driver(s) is merely exemplary and is not meant to limit the scope of the present general inventive concept.

As described above, since the virtual driver previously embedded in the image acquisition device is automatically installed if the image acquisition device is recognized by the host, the user does not need to spend time installing drivers. Further, the user can perform image scanning even when the host is unstable and lacks the real driver.

Moreover, since all the TWAIN drivers provided by respective vendors are stored in advance in the external storage device, the vendors may not need to provide users with CD-ROMs containing the necessary software drivers.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of driving a driver of an image acquisition device that is attachable to a host, the method comprising:
storing a virtual driver that corresponds to a real driver for an image acquisition device in the image acquisition device attachable to a host;
storing the real driver in an external storage device that is attachable to the host; and
activating the virtual driver to control the real driver stored in the external storage device if the image acquisition device and the external storage device are connected to the host.

2. The method of claim 1, further comprising:
recognizing the image acquisition device and the external storage device connected to the host; and
copying the virtual driver to the host if the image acquisition device is recognized.

3. The method of claim 2, wherein the copying of the virtual driver to the host comprises one of:
copying the virtual driver to the host automatically if the image acquisition device is recognized, and
allowing a user to copy the virtual driver to the host manually if the image acquisition device is recognized.

4. The method of claim 2, wherein the activating of the virtual driver comprises:
searching the external storage device for the real driver that corresponds to the virtual driver;
linking the real driver to the virtual driver; and
activating the virtual driver, which in turn activates the real driver.

5. The method of claim 4, wherein the searching of the external storage device is performed using a display unit.

6. The method of claim 1, wherein the external storage device is one of a universal serial bus memory, a portable memory card, and a memory stick.

7. The method of claim 1, wherein the virtual driver contains at least identification information of the image acquisition device and a function to link the virtual driver with the real driver.

8. The method of claim 1, wherein the host contains an image processing application as a data source manager to drive the virtual driver.

9. The method of claim 1, wherein the activating of the virtual driver comprises enabling a user to select the virtual driver by selecting one of a plurality of image acquisition devices in an image processing application program.

10. The method of claim 1, wherein the activating of the virtual driver comprises calling a function that determines one of a plurality of real drivers stored in the external storage device that corresponds to the virtual driver.

11. The method of claim 10, wherein the calling of the function comprises:
determining an address where the corresponding real driver is stored in the external storage device,
searching for the corresponding real driver at the determined address, and activating the corresponding real driver at the determined address, and
outputting a notification message when the corresponding real driver is not found at the determined address in the external storage device.

12. The method of claim 1, wherein the virtual driver comprises minimal linking information to link the image acquisition device-with the real driver.

13. A method of operating an image acquisition device that stores identification information associated therewith, the method comprising:
storing a predetermined virtual driver that corresponds to a real driver stored in an external storage device that is attachable to a host,
wherein the virtual driver activates the real driver through the host to control the image acquisition device.

14. The method of claim 13, wherein the virtual driver comprises the identification information associated with the image acquisition device and the real driver comprises software to operate the image acquisition device, and the method further comprising:
connecting the image acquisition device to the host;
connecting the external storage device that includes the software to operate the image acquisition device to the host; and
mapping the identification information stored in the image acquisition device to the software to operate the image acquisition device connected to the host.

15. The method of claim 14, further comprising:
pre-storing software to operate a plurality of predetermined image acquisition devices in the external storage device.

16. The method of claim 14, wherein the mapping of the identification information associated with the image acquisition device to the software comprises:
calling a function to input the identification information associated with the image acquisition device connected to the host and to output a storage location of the software in the external storage device.

17. The method of claim 16, wherein the function searches for the identification information in a specified directory that stores device identification information for one or more image acquisition devices.

18. The method of claim 14, further comprising:
operating the image acquisition device connected to the host without the software being stored in the host.

19. A method of operating an image acquisition device that stores identification information associated therewith, the method comprising:
storing a real driver to control an image acquisition device that is attachable to a host,
wherein the real driver corresponds to a virtual driver stored in the image acquisition device, that is attachable to the host, and is activated by the virtual driver through the host to operate the image acquisition device.

20. The method of claim 19, further comprising:
storing a plurality of real drivers to correspond to a plurality of predetermined image acquisition devices in an external storage device;
attaching the external storage device to a host; and
enabling access to a selected real driver that corresponds to the image acquisition device that is attached to the host.

21. The method of claim 20, wherein the selected driver runs on the external storage device.

22. The method of claim 20, wherein each of the plurality of real drivers comprises one or more common files that are common in the plurality of predetermined image acquisition devices, and one or more data source files that define at least one protocol and at least one function of the respective real driver.

23. The method of claim 20, wherein each of the plurality of real drivers is stored at a predetermined location in the external storage device.

24. The method of claim 20, further comprising:
copying virtual driver information stored by the image acquisition device to the host; and
linking the virtual driver information to a corresponding one of the plurality of real drivers stored on the external storage device.

25. The method of claim 24, wherein the virtual driver information comprises a device ID for the image acquisition device and a function to link the device ID with a storage location of the corresponding one of the plurality of real drivers.

26. The method of claim 20, further comprising:
enabling a user to select an image acquisition device to operate using an image processing application running on the host, and the selected real driver corresponds to the selected image acquisition device.

27. The method of claim 20, wherein the plurality of real drivers are provided by a plurality of different vendors and correspond to different image acquisition device types.

28. A system to control a driver of an image acquisition device that is attachable to a host, the system comprising:
an image acquisition device including a storage unit in which a virtual driver that corresponds to a real driver is stored;
an external storage device that is attachable to the host and in which the real driver is stored; and
a host to enable the virtual driver to be copied thereto, and to control the image acquisition device using the virtual driver that activates the real driver.

29. The system of claim 28, wherein the virtual driver contains at least identification information of the image acquisition device and a function to link the virtual driver with the real driver.

30. The system of claim 28, wherein the external storage device is one of a universal serial bus memory, a portable memory card, and a memory stick.

31. The system of claim 28, wherein if the image acquisition device is recognized by the host, the host controls the image acquisition device to copy the virtual driver to the host automatically or allows a user to manually copy the virtual driver from the image acquisition device to the host.

32. The system of claim 28, wherein the host further comprises an image processing application as a data source manager that runs on the host to activate the virtual driver.

33. The system of claim 28, wherein the host displays a warning message to a user if the external storage device is not connected to the host.

34. The system of claim 28, wherein the image acquisition device is one of a scanner, a copier, and a digital camera.

35. An image acquisition device that is attachable to a host, the image acquisition device comprising:
a virtual driver storing unit to store a predetermined virtual driver that corresponds to a real driver that is stored in an external storage device that is attachable to the host,
wherein the virtual driver activates the real driver through the host to control the image acquisition device.

36. The image acquisition device of claim 35, wherein the virtual driver contains at least identification information of the image acquisition device and a function to link the virtual driver with the real driver.

37. The image acquisition device of claim 35, wherein the external storage device is one of a universal serial bus memory, a portable memory card, and a memory stick.

38. An external storage device that attachable to a host, the external storage device comprising:
a storage unit to store a real driver to control an image acquisition device that is attachable to the host,
wherein the real driver corresponds to a virtual driver stored in the image acquisition device, that is attachable to the host, and is activated by the host through the virtual driver to operate the image acquisition device.

39. The external storage device of claim 38, wherein the virtual driver contains at least identification information of the image acquisition device and a function to link the virtual driver with the real driver.

40. The external storage device of claim 38, wherein the external storage device is one of a universal serial bus memory, a portable memory card, and a memory stick.

41. The external storage device of claim 38, wherein the storage unit stores a plurality of real drivers, and the real driver is selected from the plurality of real drivers by the virtual driver stored in the image acquisition device.

42. A host connectable to an image acquisition device and an external storage device to drive a driver for the image acquisition device, the host comprising:
a control unit to generate a signal to activate a virtual driver stored in the image acquisition device, to generate a second signal to select one of a plurality of real drivers stored in the external storage device according to the activation of the virtual driver, and to control the image acquisition device according to the selected real driver.

43. The host of claim 42, wherein the control unit receives the virtual driver from the image acquisition device according to the selected real driver to control the image acquisition device.
